(19) United States
(12) Patent Application Publication
(10) Pub. No.: US 2018/0319687 A1
(43) Pub. Date: Nov. 8, 2018

(54) SCALE INHIBITION COMPOSITION

(71) Applicant: Dyson Technology Limited, Wiltshire (GB)

(72) Inventors: Nathan Charles BROWN, Swindon (GB); James David COLEMAN, Bristol (GB); Patricia Rodrigues Da SILVA, Swindon (GB); Jonathan Campbell KNOWLES, St Albans (GB); Gareth Jon OWENS, Liverpool (GB)

(73) Assignee: Dyson Technology Limited, Wiltshire (GB)

(21) Appl. No.: 15/969,832

(22) Filed: May 3, 2018

(30) Foreign Application Priority Data
May 4, 2017 (GB) 1707114.3

(51) Int. Cl. C02F 5/06; C03C 3/16; C02F 5/04

(52) U.S. Cl. CPC C02F 5/06; C02F 2307/12; C02F 5/04; C03C 3/16

(57) ABSTRACT

A polyphosphate-based glass scale inhibition composition comprising from about 45 to about 55 mole percent P₂O₅, from about 35 to about 45 mole percent of an oxide of an alkaline earth metal, and from about 8 to about 12 mole percent of an oxide of an alkali metal.

### REFERENCE TO RELATED APPLICATIONS

This application claims the priority of United Kingdom Application No. 1707114.3, filed May 4, 2017, the entire contents of which are incorporated herein by reference.

### FIELD OF THE INVENTION

The present invention relates to a scale inhibition composition. More particularly, the present invention relates to a scale inhibiting polyphosphate glass composition particularly, but not exclusively, for preventing scale formation in domestic appliances.

### BACKGROUND OF THE INVENTION

If there are minerals present in water then these are available to form scale. Scale build up is a particular problem in hot water appliances, such as kettles and boilers, but minerals present in tap water can also form scale on other water containing appliances, such as the wetted parts of a domestic humidifier. As the hardness of the water increases, so does the nuisance of scale.

Scale formation and scale deposition are complex crystallisation processes. Dominant and well-known variables affecting the formation of scale are the temperature and pH of the water. With regard to temperature, most mineral scale-forming constituents are inversely soluble (their solubility decreases as water temperature increases). Scale is more soluble in low pH (more acidic) water. Predictably, scale readily forms on hot surfaces and evaporating surfaces. Scale forms more readily on rough surfaces than it does on smooth surfaces. Surface materials also affect the formation of scale—for example, scale will generally form more readily on copper surfaces than it will on stainless steel surfaces. Residence time, pressure and velocity/velocity gradients are also known to affect the formation of scale.

The minerals responsible for scale formation can be removed from water by distillation or by ion exchange. While this may be a practical solution in industrial-scale applications, in a domestic environment distillation and ion exchange are impractical. For example, in order to remove all the minerals from 1000 litres of hard water, e.g. 350 ppm CaCO3—this being a typical throughput in a domestic appliance, such as a humidifier, in approximately 6 months of use—it would require approximately 25 kg of deionising resin, e.g. approximately 1 kg of resin/week. This is impractical and undesirable for a domestic consumer appliance as it greatly increases the size of the appliance and is inconvenient for the user to have to regularly re-fill the appliance with de-ionising resin. Water with half the hardness would require half the amount of media, but it remains clear that the amount of media is impractical in domestic appliances.

As an alternative to mineral removal it is also known to use threshold inhibitors to prevent scale formation. This scale-control technique dates back to the 1920s and there are a number of commercially available products intended for potable water. Instead of fouling and forming hard deposits on wetted surfaces the minerals responsible for the scale formation stay in solution and suspension and pass through the water system, e.g. the domestic appliance. Threshold inhibitors function by an adsorption mechanism. As ion clusters in solution become oriented, metastable microcrystallites (highly oriented ion clusters) are formed. At the initial stage of precipitation, the microcrystallite can either continue to grow (forming a larger crystal with a well-defined lattice) or dissolve. Threshold inhibitors prevent precipitation by adsorbing on the newly emerging crystal, blocking active growth sites. This inhibits further growth and favours the dissolution reaction. The precipitate dissolves and releases the inhibitor, which is then free to repeat the process.

Threshold inhibitors delay or retard the rate of precipitation. Crystals may eventually form, depending on the degree of supersaturation and system retention time. However, in some domestic appliances where the retention time is relatively short, e.g. in a domestic ultrasonic humidifier, the dissolved minerals in the water do not form scale and are able to pass through the system—which in the case of a domestic ultrasonic humidifier means that they are discharged into the atmosphere in the emitted water droplets.

Polyphosphate-based chemicals are a known class of threshold inhibitors. Threshold inhibition only requires sub-stoichiometric quantities of the polyphosphate-based scale inhibitor chemicals in order to prevent scale formation. This means of achieving scale control should not be confused with the use of much larger (stoichiometric) quantities of polyphosphate-based chemicals used in older washing powders.

Dosing the minute quantities of the polyphosphate-based chemicals is easy to do in large-scale industry because liquid solutions of soluble polyphosphate salts can be made and these can be dosed with pumps. In domestic applications the making and accurate dosing of solutions of chemicals is impracticable and so other application methods are required. One dosing method is the use of a slowly-soluble glass. Siliphos® is a commercially-available polyphosphate-based glass threshold inhibitor manufactured by Kurita Water Industries Limited and sold in round marble form. Water is caused to be in contact with one or more marbles, which hydrolyse and release, amongst other things, a range of polyphosphate compounds. It is these polyphosphate-hydrolysis products that achieve the threshold inhibition scale control.

Siliphos® is a polyphosphate-based glass containing a mixture of up to 20 different inorganic phosphates and sodium silicates. Siliphos® functions well as a threshold inhibitor, but testing has shown that under certain conditions the marbles of Siliphos® over-dissolve and form a silt-like sediment. While this may be acceptable in certain applications there are other applications where it will not be acceptable, either because it inhibits the proper functioning of the appliance, or it is aesthetically unacceptable for a user of the product. Furthermore, the over dissolving of the marbles means that they can be used up too quickly and this can lead to the need to replace them frequently, which can be undesirable in certain applications. Another concern identified with the use of Siliphos® to control scale is that the sediment which forms when the glass hydrolyses has the potential to lead to extra nutrients which could promote microbial growth. There is some evidence to show that there is an increase in bacteria growth in sterilised tap water when Siliphos® has been added over 7 days. There is also evidence that the turbidity is greatly increased when Siliphos® is present. Clearly there will be situations when this is undesirable, for example in domestic appliances such as humidifiers.

Siliphos® is specified to be used in a cold environment on a rising main. Typically domestic appliances are in a warm environment (e.g. between 20 and perhaps as much as 30 degrees Celcius) and because the hydrolysis behaviour is driven by temperature, it is unlikely that Siliphos could be used successfully in domestic appliances.

### SUMMARY OF THE INVENTION

The present invention overcomes some of the problems of the currently available threshold inhibitors. In a first aspect of the present invention there is provided a polyphosphate-based glass scale inhibition composition comprising from about 45 to about 55 mole percent P2O5, from about 35 to about 45 mole percent of an oxide of an alkaline earth metal, and from about 8 to about 12 mole percent of an oxide of an alkali metal.

In order to achieve the desired performance characteristics necessary for scale inhibition, particularly in domestic appliances, it was determined that a slowly-soluble glass was required. As discussed above, commercially available glasses, such as Siliphos®, are effective at scale inhibition, but suffer from the problem of over-dissolving and leave a sediment, such that they are not particularly practical to use in small domestic appliances. Extensive testing has determined that the polyphosphate-based glasses according to the present invention hydrolyse at a sufficiently slow rate to provide an acceptable lifetime for use in a domestic appliance, while also delivering effective scale control by hydrolysing to release sufficient quantities of polyphosphate ions into the water. In addition, the glasses according to the present invention are fully soluble and do not leave a sediment.

Using ion exchange chromatography, it was determined that the following four polyphosphate ions were the most abundant of those released into the water by polyphosphate glasses according to the present invention:

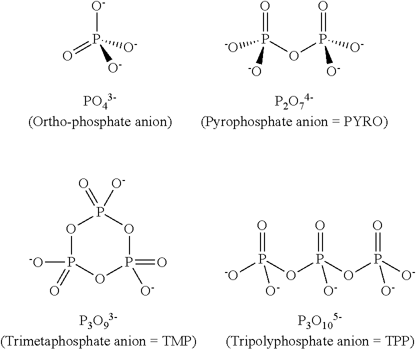

Except for PO43- (which is known not to be a scale inhibitor) these polyphosphates interact with water hardness ions to inhibit scale formation. In order to find which polyphosphate ions were most effective, single solutions of the sodium salts of each of P2O74-, P3O93-, and P3O105- were made and the feed water of three conventional domestic ultrasonic humidifiers was dosed at 2 ppm, each with one of the solutions. An ultrasonic humidifier is one which utilises a piezoelectric transducer to generate a fine mist of water droplets which are emitted into the surrounding atmosphere.

The humidifiers were run continuously as close as was practicably possible. By measuring the mist output, it was possible to determine which piezoelectric transducer was least affected by scale formation (because the mist output remained substantially constant). Based on these tests it was determined that P3O105-tripolyphosphate (TPP) was the best scale inhibitor, P2O74-pyrophosphate (PYRO) performed reasonably well, and P3O93-trimetaphosphate (TMP) was determined to be a poor threshold inhibitor.

The knowledge that TPP was the polyphosphate able to achieve the best threshold inhibition made it possible to rank glasses according to both their overall solubility and the proportion of TPP released. The finding made it possible to target a glass that releases a sufficient quantity of the best scale inhibitor (TPP) and that also has the right overall solubility. The solubility of the glass alone isn't necessarily an indication of a better scale inhibitor because it might not release useful quantities of the TPP.

In an embodiment of the invention the alkaline earth metal is selected from the group consisting of magnesium, calcium or strontium. More preferably, in an embodiment of the invention the alkaline earth metal is calcium.

In an embodiment of the invention the alkali metal is selected from the group consisting of lithium, sodium or potassium. In an embodiment of the invention the alkali metal is sodium.

In an embodiment of the invention the P2O5 is present in the range from about 45, or 46, or 47, or 48, or 49, or 50, or 51, or 52, or 53, or 54, or 55 mole percent.

In an embodiment of the invention the P2O5 is present in the range up to about 45, or 46, or 47, or 48, or 49, or 50, or 51, or 52, or 53, or 54, or 55 mole percent.

In an embodiment of the invention the alkaline earth metal oxide is present in the range from about 35, or 36, or 37, or 38, or 39, or 40, or 41, or 42, or 43, or 44, or 45 mole percent.

In an embodiment of the invention the alkaline earth metal oxide is present in the range up to about 35, or 36, or 37, or 38, or 39, or 40, or 41, or 42, or 43, or 44, or 45 mole percent.

In an embodiment of the invention the alkali metal oxide is present in the range from about 8, or 9, or 10, or 11, or 12 mole percent.

In an embodiment of the invention the alkali metal oxide is present in the range up to about 8, or 9, or 10, or 11, or 12 mole percent.

In an embodiment of the invention the preferred glass composition is (P2O5)50(CaO)40(Na2O)10.

The proposed glass compositions demonstrate an effective means of continual release of polyphosphate species with the (P2O5)50(CaO)40(Na2O)10 composition providing an efficient release of TPP per gram of glass. Further to this, the use of a silica-free glass network leads to complete dissolution of the glass and hence no sediment will form in all envisaged typical usage conditions.

With the phosphate content held constant at 50 mole percent results have shown that the efficiency of TPP release increases as the calcium oxide content increase. However, the dissolution rate has been shown to decrease as the calcium oxide content increases. Compositions with higher calcium oxide content than 40 mole percent have been shown to have unfavorable degradation rates (ie. too slow to maintain an adequate release of TPP without excessive surface area). By substituting the monovalent network modifier for an element with like valance but of varying size, the dissolution rate can be increased or decreased, therefore enabling control of the degradation rate whilst maintaining the most efficient release of TPP. It has been shown that the dissolution rate increases as the size of the modifier increases from lithium to sodium to potassium.

In an embodiment of the invention the P2O5 dosing rate in water at 22° C.±3° C. is less than or equal to 2.5 ppm.

In an embodiment of the invention the glass has a total surface area of at least 900 mm2. Advantageously, the total surface area of the glass is at least 2000 mm2. The glass may be provided as a single piece of glass, or multiple individual pieces, which could, for example, be mounted within a cartridge for ease of use. An advantage of using multiple pieces of glass within a cartridge is that the total surface area of glass can easily be adjusted by using more or less glass pieces. This can be useful for dealing with water of differing hardness, or to cope with applications having water tanks of different sizes, etc.

The glass may conveniently be manufactured in a variety of shapes to suit a variety of purposes. Some factors which could determine the shape of the glass include: the manufacturing process; any handling requirements; and the intended end use of the glass. One exemplary shape of glass according to the present invention is a cylinder. This is particularly advantageous as it can easily be cut down to suit a variety of uses.

In a second aspect, the present invention provides the use of a polyphosphate-based glass composition as previously described as a scale inhibitor in a domestic appliance.

The polyphosphate-based glass according to the present invention could be used in any water-containing domestic appliance. In an embodiment of the invention the domestic appliance is selected from the group consisting of humidifiers, dehumidifiers, kettles, water coolers, water boilers, water dispensers, water-based cleaning apparatus, water-based beauty appliances.

### BRIEF DESCRIPTION OF THE DRAWINGS

An embodiment of the present invention will now be described, by way of example only, with reference to the accompanying drawings, in which:

The single FIGURE is a ternary graph showing the compositions of a variety of polyphosphate-based glasses according to the present invention.

### DETAILED DESCRIPTION OF THE INVENTION

The present invention will now be illustrated with reference to the following example.

Samples of a variety of polyphosphate-based glasses with the general composition of (P2O5)40-65(CaO)15-50(Na2O)5-40, (where subscript adjacent to parenthesis indicates the range of mole percent of the oxides within final glass composition) were produced by standard melt-quench techniques. One such technique is described below, but it will be appreciated that glasses according to the present invention can be made by a variety of techniques and from a variety of starting materials.

The appropriate raw materials were selected, CaCO3, NaH2PO4 and P2O5, and weighed according to the expected final compositions. Then, the starting materials were placed in a Pt/10% Rh crucible type 71040 (Johnson Matthey, Royston, UK) that was then placed in a furnace pre-heated at 700° C.

After 30 min at 700° C., the furnace temperature was increased to 1100° C. and maintained for 1 h. The glass was then poured into a graphite mould pre-heated to between 360-430° C. The mould was placed back in the furnace and left at the chosen temperature for 1 h. The furnace was switched off and the glass was left inside to slowly cool to room temperature to remove any residual stress.

The mould defined a cylindrical shape and the resulting cylindrical glass rods obtained from the mould were cut into discs of 15 mm diameter and 2 mm thickness, using a Testbourne diamond saw. The total surface area of each disc is approximately 450 mm2. The discs received no further polishing or surface treatment and were used as prepared in the subsequent procedures. Glasses prepared according to the present invention can be cast into different shapes and sizes, depending on the mould in use. The surface area of the individual glass units will vary accordingly to the respective mould shape and size.

Glasses made according to this process were tested to measure their hydrolysis products and their rates of hydrolysis. Ion exchange chromatography was used to detect the hydrolysis products and those glasses which released sufficient quantities of the polyphosphate ions, particularly P3O105-tripolyphosphate (TPP) were made up in larger quantities for further investigation.

In order to assess the effectiveness of the glasses as scale inhibitors real-time service tests were conducted to determine whether the products of hydrolysis from a particular glass would be able to prevent scale from forming on wetted surfaces where it has previously been found to form in the absence of a scale inhibition composition.

The service tests were conducted using standard commercially-available ultrasonic humidifiers, where it has been found that over time scale tends to form on the piezoelectric transducer and other wetted surfaces of the humidifiers. It had been found that with hard water and no scale control such ultrasonic humidifiers lost mist output very quickly. This performance measure was determined to be useful because measuring mist output (actually a weight loss of water in a product) is straightforward. Additionally qualitative visual assessments could be made of the surface of piezoelectric transducer and other wetted areas to determine the build-up of scale.

It was necessary to determine how much of the products of hydrolysis would be required to achieve the scale control necessary to prevent both loss of mist output and to prevent general nuisance build-up of scale on wetted surfaces. It was known that (keeping temperature constant) the concentration of the products of hydrolysis would be dependent upon the surface area of the immersed glass and the throughput of water through the device. In order to achieve effective scale control it was determined that a surface area of at least 900 mm2 was required.

Control tests conducted using untreated hard water (350 ppm CaCO3) resulted in mist output being lost after between 50-100 litres of water passing through the system. The reason for this is that scale builds up on the surface of the piezoelectric transducer and prevents it from operating to atomize the water.

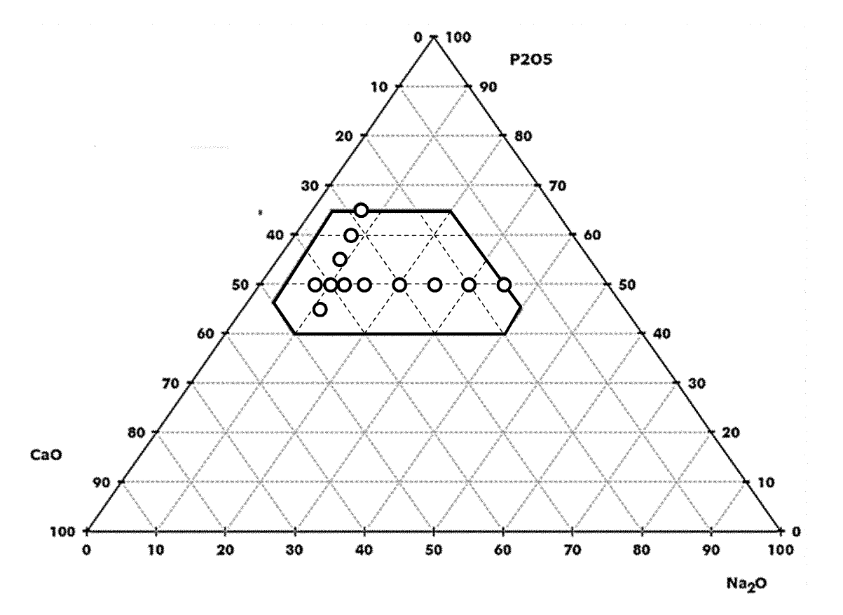

As discussed above, the present invention sets out to strike a balance between solubility of the glass and the effective release of scale inhibiting polyphosphate species. A variety of glasses were made and tested as shown in FIG. 1.

The area within the polygon shown in FIG. 1 represents the glass compositions which fall within the scope of the present invention and the circles represent glasses which were made and tested in the service tests. All of the glasses tested were found to exhibit scale control and to significantly extend the life of the humidifier beyond the 50-100 litres water throughput achieved in the humidifier with hard water and no added scale inhibitor.

The glass which was found to have the optimal characteristics of solubility and species release was (P2O5)50(CaO)40(Na2O)10. Glasses made to this composition functioned consistently and sufficiently protected against scale formation on all wetted parts, including the piezoelectric transducer up to a throughput of over 1000 litres of hard water (350 ppm CaCO3). In addition to this, the glasses demonstrated properties which would make them commercially attractive. In particular they remained intact under a wider range of ambient storage conditions than commercially-available alternatives, such as Siliphos®.

In addition to the glass compositions shown in FIG. 1 glasses were also tested which substituted the calcium for magnesium or strontium, and the sodium for lithium or potassium. These glasses exhibited good degradation rate whilst maintaining the most efficient release of TPP. It is envisaged that they could provide alternative polyphosphate-based glasses which may be preferred in certain applications.

The (P2O5)50(CaO)40(K2O)10 glass was as good a threshold inhibitor and was twice as soluble as the favoured (P2O5)50(CaO)40(Na2O)10 composition. However, the glass developed a crust in use. While this crust did not affect the performance of the glass it was deemed to be aesthetically unacceptable for applications in which it will be visible to a user. However, it is envisaged that there may be applications where the glass will not be visible in use and where the increased solubility may offer improved performance.

A (P2O5)50(SrO)25(Na2O)25 glass was also made according to the method described above. The glass was slightly more soluble than (P2O5)50(CaO)40(Na2O)10 and was an effective threshold inhibitor. It is envisaged that it may be more difficult to get safety approval for the use of glasses containing strontium, for example in domestic appliances, but there may be applications where this is not an issue.

1. A polyphosphate-based glass scale inhibition composition comprising from 45 to 55 mole percent P₂O₅, from 35 to 45 mole percent of an oxide of an alkaline earth metal, and from 8 to 12 mole percent of an oxide of an alkali metal.

2. The polyphosphate-based glass scale inhibition composition of claim 1, wherein the alkaline earth metal is selected from the group consisting of magnesium, calcium or strontium.

3. The polyphosphate-based glass scale inhibition composition of claim 1, where the alkali metal is selected from the group consisting of lithium, sodium or potassium.

4. The polyphosphate-based glass scale inhibition composition of claim 2, wherein the alkaline earth metal is calcium.

5. The polyphosphate-based glass scale inhibition composition of claim 3, wherein the alkali metal is sodium.

6. The polyphosphate-based glass scale inhibition composition of claim 1, wherein the P₂O₅ is present in the range from 48 to 52 mole percent.

7. The polyphosphate-based glass scale inhibition composition of claim 1, wherein the alkaline earth metal oxide is present in the range from 38 to 42 mole percent.

8. The polyphosphate-based glass scale inhibition composition of claim 1, wherein the alkali metal oxide is present in the range from 9 to 11 mole percent.

9. The polyphosphate-based glass scale inhibition composition of claim 1, wherein the P₂O₅ dosing in water at 22° C.±3° C. is less than or equal to 2.5 ppm.

10. The polyphosphate-based glass scale inhibition composition of claim 1 having a surface area of at least 900 mm².

11. The polyphosphate-based glass scale inhibition composition of claim 1 having a surface area of at least 2000 mm².

12. Use of a polyphosphate-based glass scale inhibition composition of claim 1 as a scale inhibitor in a domestic appliance.
